(19) United States
(12) Patent Application Publication
(10) Pub. No.: US 2025/0097343 A1
(43) Pub. Date: Mar. 20, 2025

(54) System and Method with Key Moment-Based Snippet Creation

(71) Applicant: Gryphon Networks Corp., Boston, MA (US)

(72) Inventors: Jeffrey D. Fotta, Hilton Head, SC (US); Brian David Steele, Wellesley, MA (US)

(21) Appl. No.: 18/469,289

(22) Filed: Sep. 18, 2023

(51) Int. Cl. H04M 3/42; H04M 3/22

(52) U.S. Cl. CPC H04M 3/42221; H04M 3/2227

(57) ABSTRACT

A computer-implemented method and system perform key moment-based snippet creation. The method comprises locating, automatically via at least one processor, a key moment of a call in a representation of the call and creating, automatically via the at least one processor, a snippet of the representation of the call based on the key moment located. The snippet includes the key moment and context for the key moment. The context includes a lead portion and a lag portion. The lead portion precedes the key moment, and the lag portion follows the key moment in the representation of the call. The key moment may be an utterance identified by an artificial (AI) model as having a positive or negative impact on an outcome effectuated by the call. The snippet, including the key moment, may serve as a learning tool to coach a user in a manner that improves an outcome of a next call. Such coaching may be referred to as AI-driven coaching.

### BACKGROUND

Conversational artificial intelligence (AI) is AI that a real person can talk to or interact with. Examples of conversational AI include chatbots, virtual agents, and voice assistants. Conversation intelligence is different from conversational intelligence. Conversation intelligence uses AI to analyze conversations between real persons and extract meaningful insights from such conversations.

### SUMMARY

According to an example embodiment, a computer-implemented method comprises locating, automatically via at least one processor, a key moment of a call in a representation of the call. The computer-implemented method further comprises creating, automatically via the at least one processor, a snippet of the representation of the call based on the key moment located. The snippet includes the key moment and context for the key moment. The context includes a lead portion and a lag portion. The lead portion precedes the key moment in the representation of the call. The lag portion follows the key moment in the representation of the call.

The computer-implemented method may further comprise outputting, automatically via the at least one processor, a representation of the snippet. The outputting may include storing the representation of the snippet in at least one memory, outputting the representation of the snippet as audio, outputting the representation of the snippet as text representing the audio, or a combination thereof.

The representation of the call may be an audio recording of the call or an audio transcript of the audio recording.

The key moment may be an utterance identified by an artificial intelligence (AI) model as having a positive or negative impact on an outcome effectuated by the call.

The computer-implemented method may further comprise outputting, automatically via the at least one processor, a representation of the snippet. The outputting may include transmitting the representation of the snippet to an electronic device. The transmitting may be based on at least one filter setting received from the electronic device. The at least one filter setting may correspond to the key moment.

Locating the key moment may be based on an indicator of the key moment. The indicator may be a timestamp or tag included in metadata of the representation of the call. The computer-implemented method may further comprise identifying the indicator by parsing the metadata.

The computer-implemented method may further comprise, by the at least one processor: identifying the key moment via at least one AI model, producing an indicator for the key moment identified, and locating the key moment based on the indicator produced.

The computer-implemented method may further comprise locating the key moment based on a received indicator of the key moment.

The call may be between an agent and a customer for non-limiting example. The agent may be a sales agent for non-limiting example. The call may be a sales call for non-limiting example. The key moment may be an utterance spoken by the sales agent or the customer. The key moment may be an utterance identified by an AI model as having a positive or negative impact on a sales outcome.

The lead portion may include at least one utterance spoken by the agent or customer prior to the key moment. The lag portion may include at least one utterance spoken by the agent or customer after the key moment.

The lead portion and lag portion may represent at least ten seconds of talk time between the agent and customer immediately before and after the key moment, respectively.

The computer-implemented method may further comprise, by the at least one processor: storing, in at least one memory, a collection of snippets associated with the agent and adding the snippet created to the collection stored. The snippet created may be searchable and filterable in the collection stored in the at least one memory, by the at least one processor, based on the key moment.

The computer-implemented method may further comprise, by the at least one processor, adding the snippet created to a collection of snippets stored in at least one memory. Each snippet of the snippets may be associated with a respective key moment. The computer-implemented method may further comprise, by the at least one processor, retrieving the collection stored from the at least one memory responsive to receipt of an application specific interface (API) call. The API call may be issued by a mobile application (app) executing on a mobile device. The API call may include a filter. The computer-implemented method may further comprise, by the at least one processor, searching the collection retrieved based on the filter, and locating the snippet created in the collection retrieved and searched in an event the filter identifies the key moment. The computer-implemented method may further comprise, by the at least one processor, outputting a representation of the snippet created, automatically, to the mobile app of the mobile device in an event the snippet created is located.

The computer-implemented method may further comprise, by the at least one processor, adding the snippet created to a plurality of snippets of a collection stored in at least one memory. The collection may be associated with the agent. The computer-implemented method may further comprise, by the at least one processor, retrieving the collection stored from the at least one memory responsive to receipt of an API call, the API call issued by a mobile app of a mobile device, and outputting, on a snippet-by-snippet basis, respective representations of snippets of the plurality of snippets of the collection retrieved to the mobile app of the mobile device.

According to another example embodiment, a system may comprise at least one processor. The at least one processor may be configured to locate, automatically, a key moment of a call in a representation of the call. The at least one processor may be further configured to create, automatically, a snippet of the representation of the call based on the key moment located. The snippet may include the key moment and context for the key moment. The context may include a lead portion and a lag portion. The lead portion may precede the key moment in the representation of the call. The lag portion may follow the key moment in the representation of the call.

Alternative system embodiments parallel those described above in connection with the example computer-implemented method embodiment.

According to another example embodiment, a computer-implemented method comprises, by at least one processor, issuing an application programming interface (API) call to retrieve a collection of snippets associated with calls between an agent and at least one customer for non-limiting example. The agent may be referred to interchangeably herein as a first speaker and the at least one customer may be referred to interchangeably herein as at least one second speaker. The collection is associated with the agent. The computer-implemented method may further comprise, by the at least one processor, automatically playing snippets from the collection retrieved via the API call. The playing may include producing an audible representation of the snippets, a visual representation of the snippets, or a combination thereof, on snippet-by-snippet basis. The snippets may include respective key moments and associated context from representations of the calls between the agent and the at least one customer. The associated context may include a lead portion and a lag portion. The lead portion may precede a respective key moment in a representation of a call of the representations of the calls. The lag portion follows the respective key moment in the representation of the call.

According to another example embodiment, a mobile device includes at least one processor. The at least one processor is configured to issue an application programming interface (API) call to retrieve a collection of snippets associated with calls between an agent and at least one customer. The collection is associated with the agent. The at least one processor is further configured to automatically play snippets from the collection retrieved via the API call. The playing includes producing an audible representation of the snippets, a visual representation of the snippets, or a combination thereof, on snippet-by-snippet basis, the snippets include respective key moments and associated context from representations of the calls between the agent and the at least one customer. The associated context includes a lead portion and a lag portion. The lead portion precedes a respective key moment in a representation of a call of the representations of the call. The lag portion follows the respective key moment in the representation of the call.

It should be understood that example embodiments disclosed herein can be implemented in the form of a method, apparatus, system, or computer readable medium with program codes embodied thereon.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a block diagram of a user listening to an audible representation of a snippet via a user device and viewing a visual representation of the snippet on a display screen of the user device.

FIG. 2A is a block diagram of an example embodiment of a conversation intelligence system and a user device.

FIG. 2B is a block diagram of an example embodiment of a snippet.

FIG. 3A is a block diagram of an example embodiment of a display screen of a user device with a snippet including a key moment characterized as empathy displayed thereon.

FIG. 3B is another block diagram of the display screen of the user device of FIG. 3A.

FIG. 4 is a flow diagram of an example embodiment of a computer-implemented method.

FIG. 5 is a flow diagram of another example embodiment of a computer-implemented method.

FIG. 6A is a visual representation of an example embodiment of an authentication screen.

FIG. 6B is a visual representation of an example embodiment of a preferences screen.

FIG. 7 is a visual representation of an example embodiment of a home screen.

FIG. 8A is a visual representation of an example embodiment of an action screen.

FIG. 8B is a visual representation of an example embodiment of a list of saved calls.

FIG. 9A is a visual representation of an example embodiment of a search query.

FIG. 9B is a visual representation of an example embodiment of an interface that may be loaded responsive to selecting a result of the search query.

FIG. 10 is a visual representation of an example embodiment of a user profile.

FIGS. 11A and 11B are visual representations of example embodiments of screens in a dark mode that may be selected by a user via a preferences screen.

FIG. 12 is a block diagram of an example internal structure of a computer optionally within an embodiment disclosed herein.

### DETAILED DESCRIPTION

A description of example embodiments follows.

While an example embodiment disclosed herein may describe a user device as a mobile device, it should be understood that the user device is not limited to a mobile device and may be another type of electronic device employed by a user that has a display screen and audio capability, such as a laptop, tablet, desktop, etc. for non-limiting examples. Further, while a call may be disclosed herein as being between an agent and a customer and described as a sales call, it should be understood that the call is not limited to being between an agent and a customer and need not be a sales call. In addition, while an application (app) may be described herein as being a mobile app, it should be understood that such an app is not limited thereto.

Managers and team leaders for sales organizations that primarily use a phone for sales and marketing struggle to find the best calls to coach their sales representatives (reps) on how to improve. An example embodiment disclosed herein may employ impactful moments of a call to enable coaching. It should be understood that such coaching is not limited to coaching of a sales representative. Such impactful moments impact an outcome and may be referred to interchangeably herein as key insights or key moments. Key moments may be identified via machine learning models, such as artificial intelligence (AI) models.

An example embodiment may utilize such key moments for creating snippets of the call. In this way, an example embodiment may transform a call into at least one snippet. For non-limiting example, a snippet may include one or more sentences by a single speaker that precede and follow the key moment utterance, as well as the key moment utterance itself. Providing a short but meaningful snippet of audio and corresponding transcript to review allows users, such as managers for non-limiting example, to quickly listen to a collection of snippets, wherein such collection may be pre-curated playlist for non-limiting example, that may be created and managed according to an example embodiment disclosed herein.

AI models are an existing capability available on conversation intelligence platforms, where recorded calls may be transcribed into text. Such transcriptions may be analyzed by the AI models to identify a key moment(s) in a conversation that impacts an outcome, such as a sale's outcome for non-limiting example. AI models typically require hundreds or thousands of conversation transcripts that must be tagged manually by humans to build/train an initial model that identifies key moments.

An example embodiment of a snippet generation feature disclosed herein may leverage existing AI models that evaluate a conversation transcript and identify key moments that lead to positive or negative outcomes. An example embodiment of an application (app) may leverage such AI model-identified key moments to create snippets in a playlist for the application. The app may be a mobile app that is deployed on a mobile device for non-limiting example.

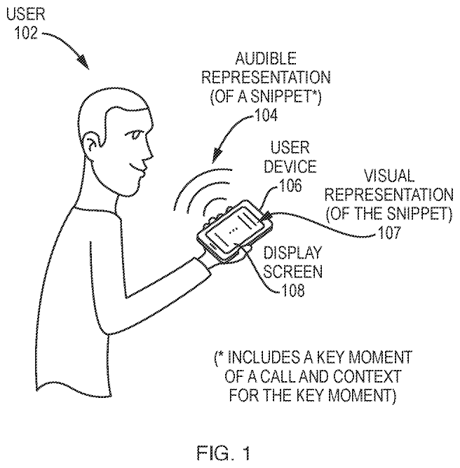

For non-limiting example, a snippet may include an entirety of an utterance identified by an AI model as a key moment, include one or more utterances prior to the key moment, such as at least ten seconds of talk time preceding the key moment, and include one or more utterances after the key moment, such as at least ten seconds of talk time following the key moment. Such an app may execute on a user device, such as the user device of FIG. 1, disclosed below.

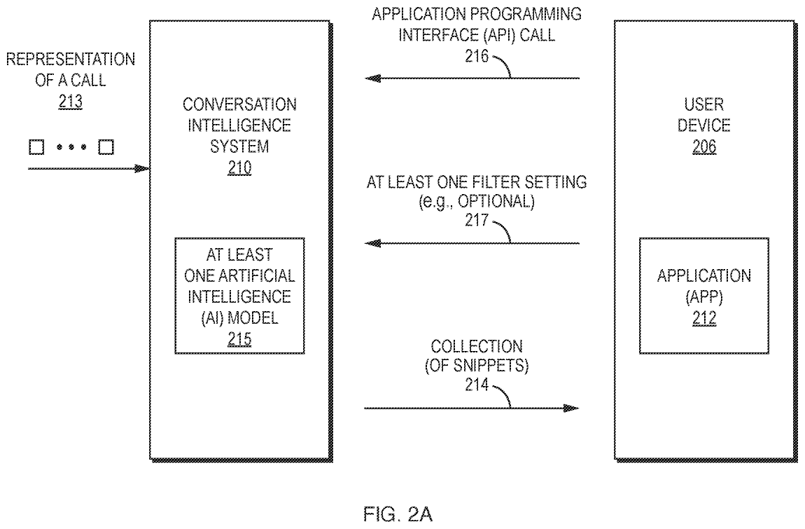

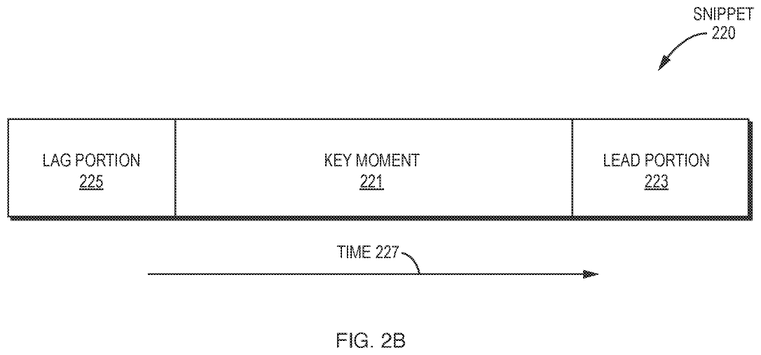

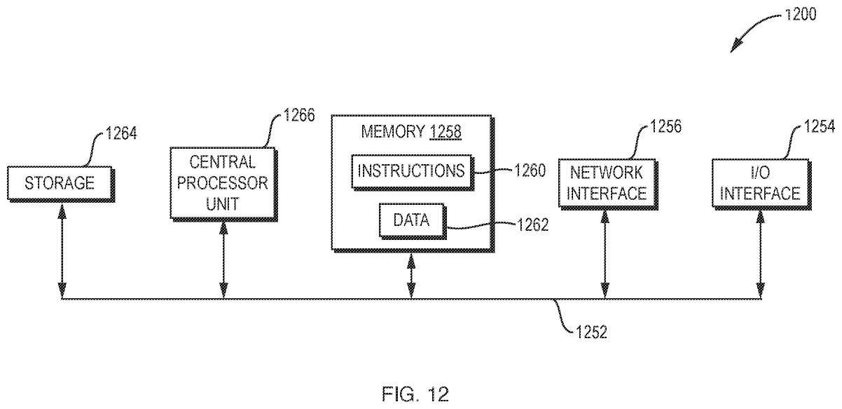

FIG. 1 is a block diagram of a user 102 listening to an audible representation 104 of a snippet (not shown) via a user device 106. In the example embodiment of FIG. 1, a visual representation 108 of the snippet is displayed on a display screen 108 of the user device 106. Such visual representation 108 of the snippet may be text that represents the audible representation 104 of the snippet. The user device 106 may be a mobile device for non-limiting example. The user device 106 may include at least one processor, such as the central processor unit 1266 of FIG. 12, disclosed further below. Continuing with reference to FIG. 1, the at least one processor may be configured to execute an application, referred to interchangeably herein as an “app,” such as a mobile app for non-limiting example. According to an example embodiment, the application may retrieve a snippet or a collection of snippets via an application-programming interface (API) call to a system, such as the conversation intelligence system 210 of FIG. 2A, disclosed below.

FIG. 2A is a block diagram of an example embodiment of a conversation intelligence system 210 and a user device 206. The user device 206 may be the user device 106 of FIG. 1, disclosed above, and may be a mobile device for non-limiting example.

The system 210 may comprise at least one processor, such as the central processor unit 1266 of FIG. 12, disclosed further below. Continuing with reference to FIG. 2A, the at least one processor may be configured to locate, automatically, a key moment (not shown) of a call (not shown) in a representation of the call 213. The at least one processor may be configured to create, automatically, a snippet (not shown) of the representation of the call based on the key moment located. The snippet may include the key moment and context (not shown) for the key moment. The context may include a lead portion (not shown) and a lag portion (not shown). The lead portion may precede the key moment in the representation of the call. The lag portion may follow the key moment in the representation of the call, as disclosed further below with regard to FIG. 2B.

Continuing with reference to FIG. 2A, the at least one processor of the system 210 may be further configured to output, automatically, a representation of the snippet. The outputting may include storing the representation of the snippet in at least one memory (not shown), outputting the representation of the snippet as audio (not shown), outputting the representation of the snippet as text (not shown) representing the audio, or a combination thereof. According to an example embodiment, the representation of the snippet may be included in a collection 214 of snippets, such as a playlist for non-limiting example, as disclosed further below.

The representation of the call may be an audio recording (not shown) of the call or an audio transcript (not shown) of the audio recording. For non-limiting example, the call may be between an agent (not shown) and a customer (not shown). The agent may be a sales agent and the call may be a sales call for non-limiting examples. The key moment may be an utterance spoken by the sales agent or the customer for non-limiting example. The key moment may be an utterance identified by at least one artificial intelligence (AI) model 215 as having a positive or negative impact on an outcome, such as a sales outcome for non-limiting example. As such, the key moment may be an utterance identified by the at least one AI model 215 as having a positive or negative impact on an outcome effectuated by the call.

The at least one processor of the system 210 may be further configured to output a representation of the snippet by transmitting the representation of the snippet to an electronic device, such as the user device 206. The transmitting may be based on at least one filter setting 217 received from the electronic device. The at least one filter setting 217 may correspond to the key moment.

The at least one processor of the system 210 may be further configured to locate the key moment based on an indicator (not shown) of the key moment. The indicator may be a timestamp or tag included in metadata (not shown) of the representation of the call 213. The at least one processor may be further configured to identify the indicator by parsing the metadata. For example, the at least one AI model 215 may be external to the system 210 and employed by another system (not shown) to identify the key moment and provide the representation of the call 213 to the system 210. Alternatively, the at least one AI model 215 may be internal to the system 210.

The at least one processor of the system 213 may be further configured to identify the key moment via the at least one AI model 215, produce the indicator for the key moment identified, and locate the key moment based on the indicator produced. Alternatively, the at least one processor of the system 210 may be further configured to locate the key moment based on a received indicator (not shown) of the key moment.

As disclosed above, the call may be between an agent and a customer for non-limiting example. The system 210 may include at least one memory (not shown). The at least one processor of the system 210 may be further configured to store, in the at least one memory, a collection (not shown) of snippets associated with the agent. The at least one processor may be further configured to add the snippet created to the collection stored. The snippet created may be searchable and filterable, in the collection stored in the at least one memory, by the at least one processor based on the key moment.

Each snippet of the collection of snippets may be associated with a respective key moment. The at least one processor of the system 210 may be further configured to retrieve the collection stored from the at least one memory responsive to receipt of an application specific interface (API) call 216. The API call may be issued by an application (app) 212 executing on the user device 206 that may be a mobile device for non-limiting example.

The API call 216 may include a filter (not shown), such as the at least one filter setting 217, or the user device 206 may be configured to transmit the at least one filter setting 217 separately from the API call 216. The at least one processor of the user device 206 may be further configured to search the collection retrieved based on the filter and locate the snippet created in the collection retrieved and searched, in an event the filter identifies the key moment. The at least one processor may be further configured to output a representation of the snippet, automatically, to the app 212 of the user device 206 in an event the snippet created is located. Such snippet may be output as part of the collection 214 for non-limiting example.

According to an example embodiment, the user device 206 may include at least one processor that may be configured to execute an application 212, that may be a mobile application for non-limiting example. The application 212 may include a sequence of instructions which, when loaded and executed by at least one processor, causes the at least one processor to issue an API call 216 to retrieve the collection 214 of snippets.

The collection of snippets may be associated with calls between an agent (not shown) and at least one customer (not shown) for non-limiting example. The collection 214 may be associated with the agent. The at least one processor of the user device 206 may be further caused to automatically play snippets from the collection retrieved via the API call 216. The snippets may be played on the user device 206 that may be a mobile device for non-limiting example. The playing may include producing an audible representation of the snippets, a visual representation of the snippets, or a combination thereof, on snippet-by-snippet basis. The snippets may include respective key moments (not shown) and associated context (not shown) from representations of the calls between the agent and the at least one customer. The associated context may include a lead portion and a lag portion. The lead portion may precede a respective key moment in a representation of a call of the representations of the call and the lag portion may follow the respective key moment in the representation of the call such as disclosed below with reference to FIG. 2B.

FIG. 2B is a block diagram of an example embodiment of a snippet 220. The snippet includes a key moment 221 and associated context that includes a lead portion 223 and a lag portion 225. The lead portion 223 precedes the key moment 221 and the lag portion 225 follows the key moment 221 in a representation of a call (not shown), such as an audible or visual representation of the call. The call may be a recorded call. The lead portion 223 and lag portion 225 may precede and follow the key moment 221, respectively, with respect to time 227.

The call may be between an agent and a customer for non-limiting example. The lead portion 223 may include at least one utterance (not shown) spoken by the agent or customer prior to the key moment 221. The lag portion 225 may include at least one utterance spoken by the agent or customer after the key moment 221. The lead portion 223 and lag portion 225 may represent at least ten seconds of talk time between the agent and customer immediately before and after the key moment 221, respectively.

### Playlist and Snippet Filtering

With reference back to FIG. 2A, according to an example embodiment, the application 212 may retrieve the collection 214 of snippets via an API call 216 to the conversation intelligence system 210. Such snippets may be searchable and filterable by a key moment (not shown). Users of the application, such as the user 102 of FIG. 1, disclosed above, may be provided with predefined lists based on key moments and a speaker, such as listed below in Table 1 for non-limiting example. For non-limiting example, such speaker may be identified as a customer or agent as shown below in Table 1.

TABLE 1

| Key Moment | Speaker |
|---|---|
| Do Not Call | Customer |
| Objection Language | Customer |
| Dissatisfaction | Customer |
| Sales Ownership | Agent |
| Touting Behavior | Agent |
| Upsell/Cross-Sell | Agent |
| Assumptive Close | Agent |
| Probing Questions | Agent |
| Breaking Barriers | Agent |
| Payment Language | Agent |
| Empathy | Agent |
| Politeness | Agent |

### Navigation

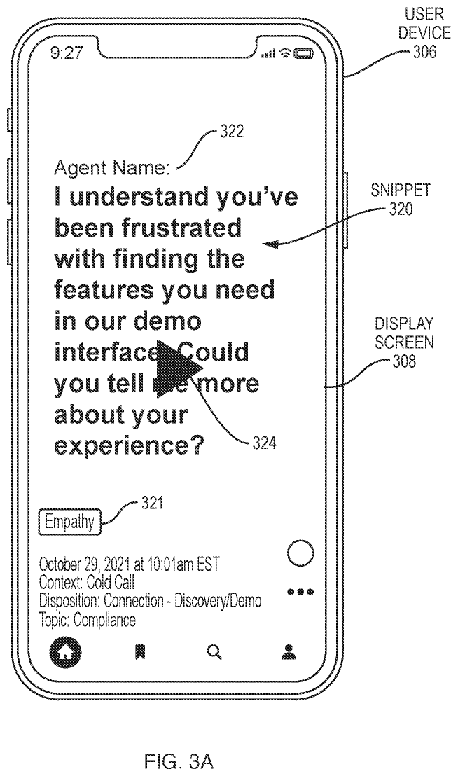

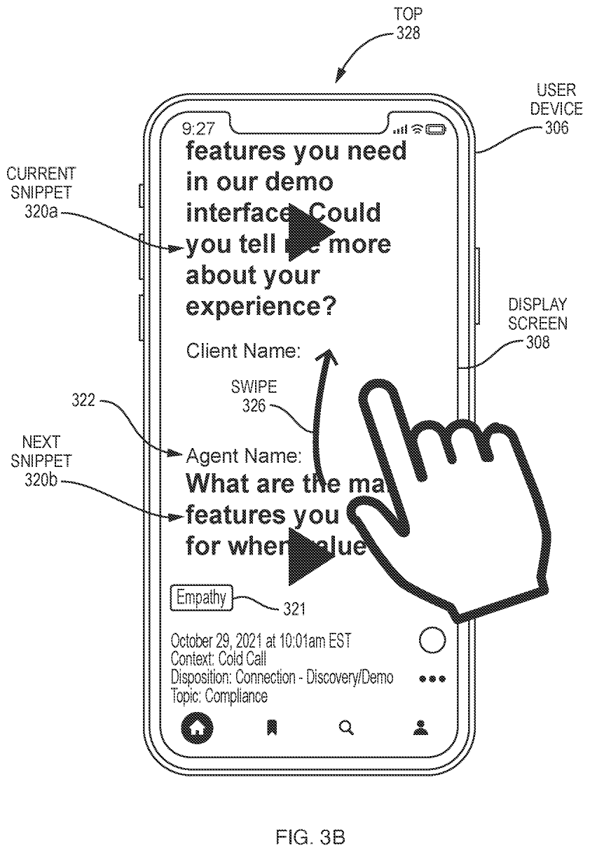

Continuing with reference to FIG. 1 and FIG. 2A, according to an example embodiment, the user 102 may swipe up on the display screen 108 of the user device 106. Such swiping may enable the user 102 to navigate from snippet to snippet in the collection 214 of snippets within the application 212 executing on the user device 206. In response to the user 102 swiping up on the display screen 108 to navigate from a current snippet (not shown) to a next snippet (not shown) in the collection 214, the application 212 may automatically start playing the next snippet in the collection 214 based on a current filter (not shown), as disclosed below with regard to FIG. 3A and FIG. 3B.

FIG. 3A is a block diagram of an example embodiment of a display screen 308 of a user device 306 with a snippet 320 including a key moment characterized as empathy 321 displayed thereon. With reference to FIGS. 1, 2, and 3A, the key moment of the snippet 320 represents empathy 321 by an agent (not shown) with an agent name 322. The key moment has been identified and generated as the snippet 320 of audio and transcript for the user 102, who may be a manager of the agent, to listen to as part of a playlist, such as the collection 214 that may be a playlist. For example, a play button 324 on the display screen 308 may be used by the user 102 to listen to the snippet of audio and to read the transcript in its entirety. If, however, the snippet 320 is not of interest to the user 102, the user may, for non-limiting example, swipe up on the display screen 308, as disclosed below with regard to FIG. 3B.

FIG. 3B is another block diagram of the display screen 308 of the user device 306 of FIG. 3A. In the example embodiment of FIG. 3B, the display screen 308 has multiple snippets displayed thereon, namely a current snippet 320a and a next snippet 320b each including respective key moments characterized as empathy 321. With reference to FIG. 1, FIG. 2A, and FIG. 3B, if the current snippet 320 is not of interest to the user 102, the user 102 may swipe 326 the display screen 308 using an upward motion toward a top 328 of the display screen 308 to listen to the next snippet 320b in the collection 214 that may be an AI curated playlist.

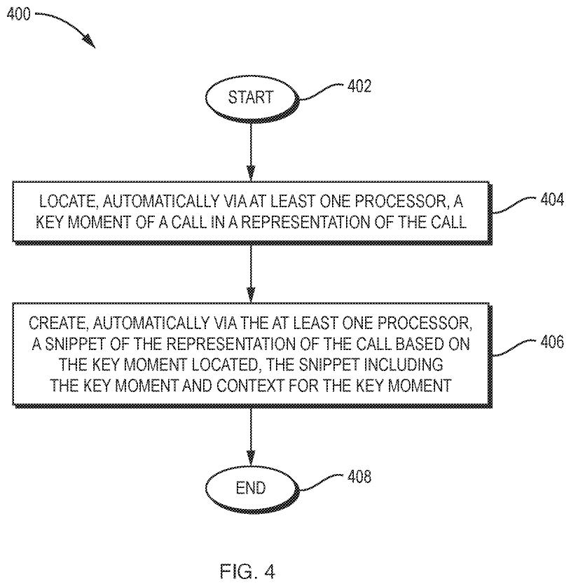

FIG. 4 is a flow diagram 400 of a computer-implemented method. The computer-implemented method begins (402) and comprises locating, automatically via at least one processor, a key moment of a call in a representation of the call (402). The computer-implemented method further comprises creating, automatically via the at least one processor, a snippet of the representation of the call based on the key moment located (404). The snippet includes the key moment and context for the key moment. The context includes a lead portion and a lag portion. The lead portion precedes the key moment in the representation of the call. The lag portion follows the key moment in the representation of the call. The method thereafter ends (408) in the example embodiment.

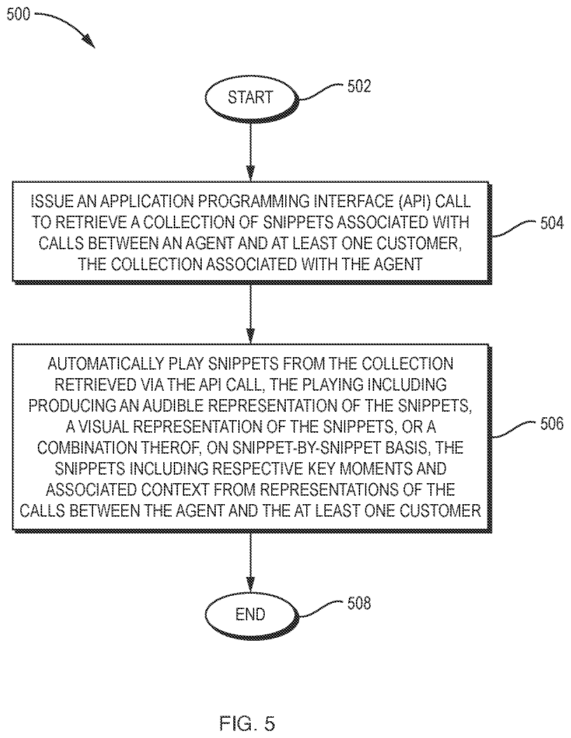

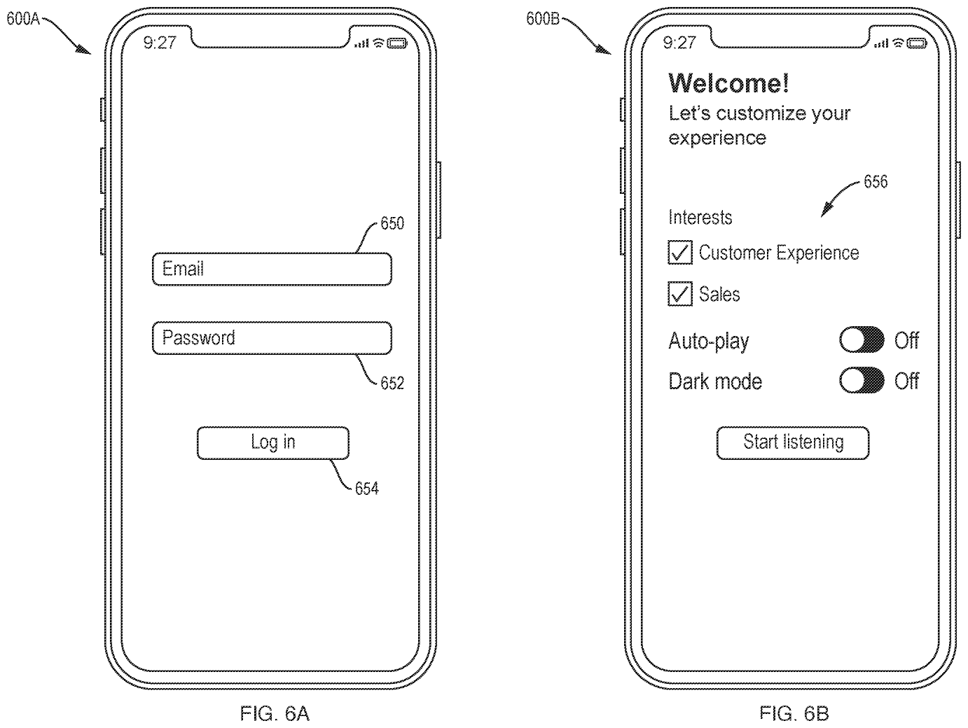

FIG. 5 is a flow diagram 500 of another example embodiment of a computer-implemented method. The computer implemented method begins (502) and comprises, by at least one processor, issuing an application programming interface (API) call to retrieve a collection of snippets associated with calls between an agent and at least one customer (504). The collection is associated with the agent. The computer-implemented method further comprises, by the at least one processor, automatically playing snippets from the collection retrieved via the API call (506). The playing includes producing an audible representation of the snippets, a visual representation of the snippets, or a combination thereof, on snippet-by-snippet basis. The snippets include respective key moments and associated context from representations of the calls between the agent and the at least one customer. The associated context includes a lead portion and a lag portion. The lead portion precedes a respective key moment in a representation of a call of the representations of the calls. The lag portion follows the respective key moment in the representation of the call. The computer-implemented method thereafter ends (508) in the example embodiment. With referenced to FIG. 2A and FIG. 5, an example embodiment of a method according to the flow diagram 500 may be implemented on the user device 206 that may be a mobile device. Example embodiments of visual representations of a user interface driven by the application 212 are disclosed below with regard to FIGS. 6A through 11B.

FIG. 6A is a visual representation 600A of an example embodiment of an authentication screen. In the visual representation 600A, a user enters an email 650 and password 652 to log in 654 to an existing account.

FIG. 6B is a visual representation 600B of an example embodiment of a preferences screen that provides preferences 656 for a first-time user. According to an example embodiment, such preferences may be subsequently accessed through the user's profile.

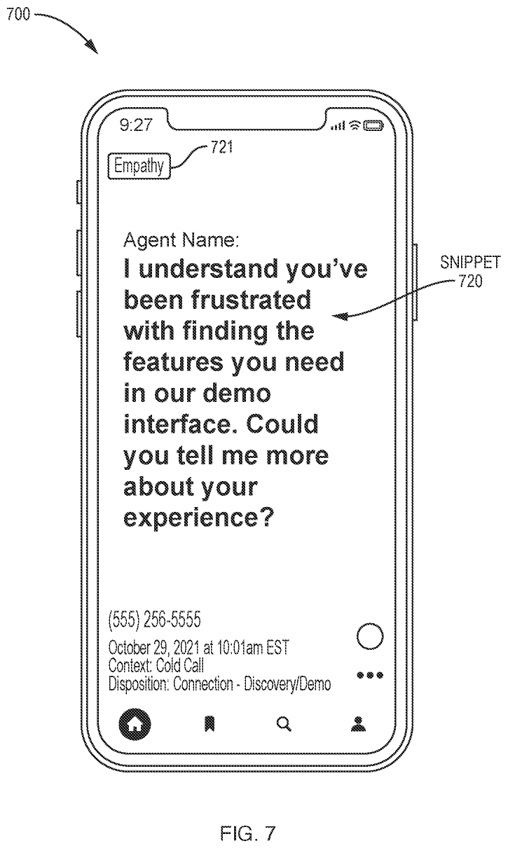

FIG. 7 is a visual representation 700 of an example embodiment of a home screen that includes a snippet 720. The snippet 720 may be generated based on a key moment (not shown) that is associated with empathy 721 for non-limiting example. The home screen, that is, the visual representation 700, may display one clip at time, namely, one snippet at a time. A user may swipe the home screen up/down leading to a next/previous call in a playlist of calls. Sliding the home screen from left to right may enable the user to listen to the call audio/transcript. The snippet 720 may be referred to as an artificial intelligence (AI) snippet as the key moment included in the snippet 720 may be identified via at least one AI model.

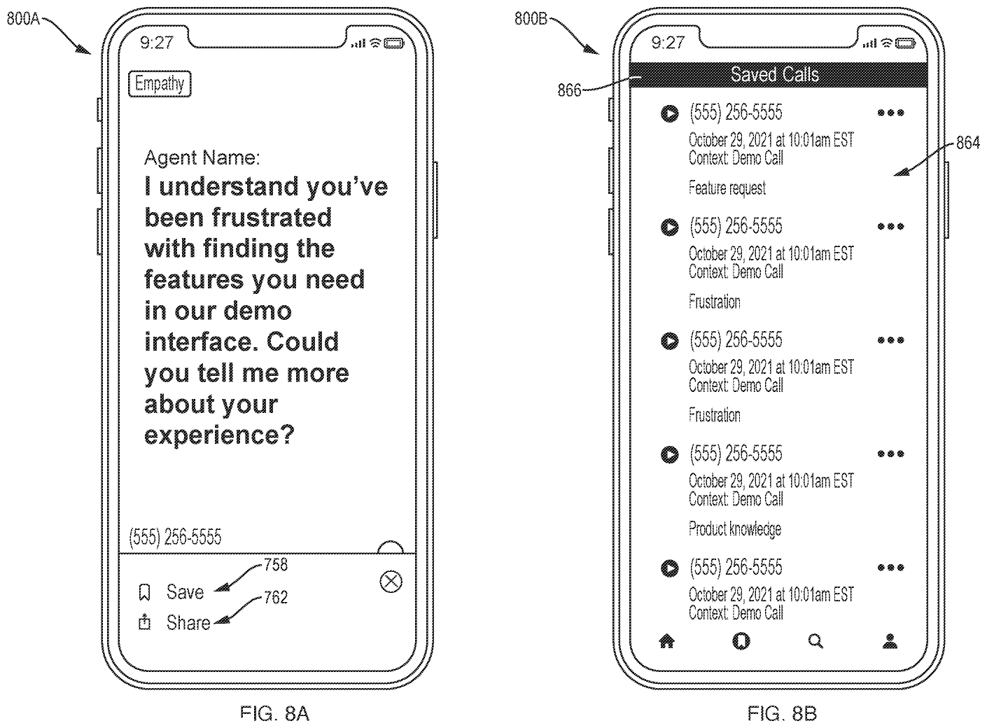

FIG. 8A is a visual representation 800A of an example embodiment of an action screen in which a user can save 758 a call, via local storage on the user device for non-limiting example, or the user may share 762 it via use of the user device's native sharing options. The action screen may be accessed by the user via an ellipsis icon (not shown) for non-limiting example.

FIG. 8B is a visual representation 800B of an example embodiment of a list 864 of saved calls 866. For non-limiting example, a bookmark icon of a main menu (not shown) may be employed to access the list 864.

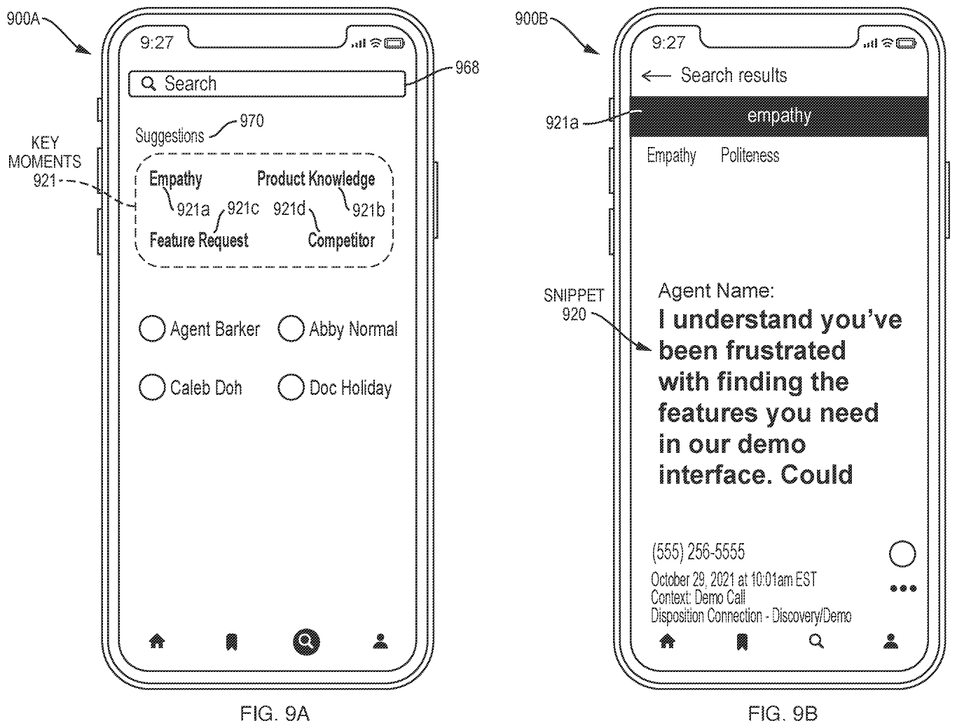

FIG. 9A is a visual representation 900A of an example embodiment of a search query 968. A user may type the search query 968 or tap one of the suggestions 970 for key moments 921. The key moments 921 include empathy 921a, product knowledge 921b, feature request 921c, and competitor 921d for non-limiting examples. Search results may be shown in a list (not shown) that may be displayed in a similar manner as the list 864 of FIG. 8B, disclosed above. Selecting a result from the list may cause an interface to be loaded, such as the interface disclosed below with regard to FIG. 9B.

FIG. 9B is a visual representation 900B of an example embodiment of an interface that may be loaded responsive to selecting a result, as disclosed above with regard to FIG. 9A. The selected result if for the key moment empathy 921a. Such key moment is expressed in the snippet 920. According to an example embodiment, a user may scroll up/down to move to the next/previous search result via the interface.

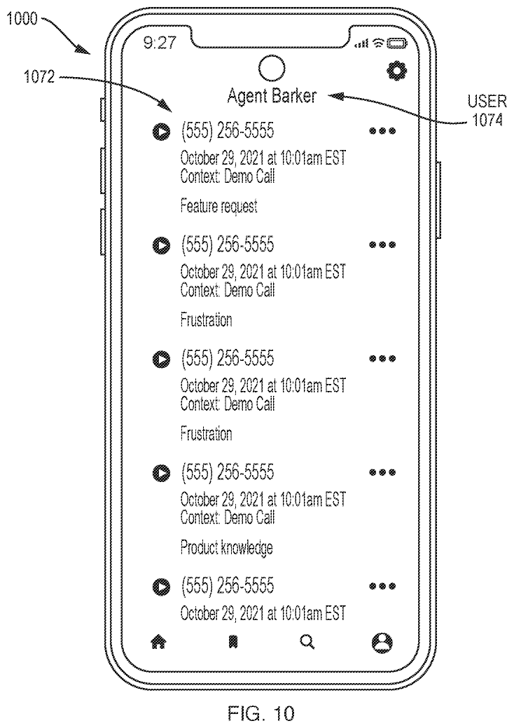

FIG. 10 is a visual representation 1000 of an example embodiment of a user profile. The visual representation 1000 includes a display of calls 1072 that the user 1074 has made.

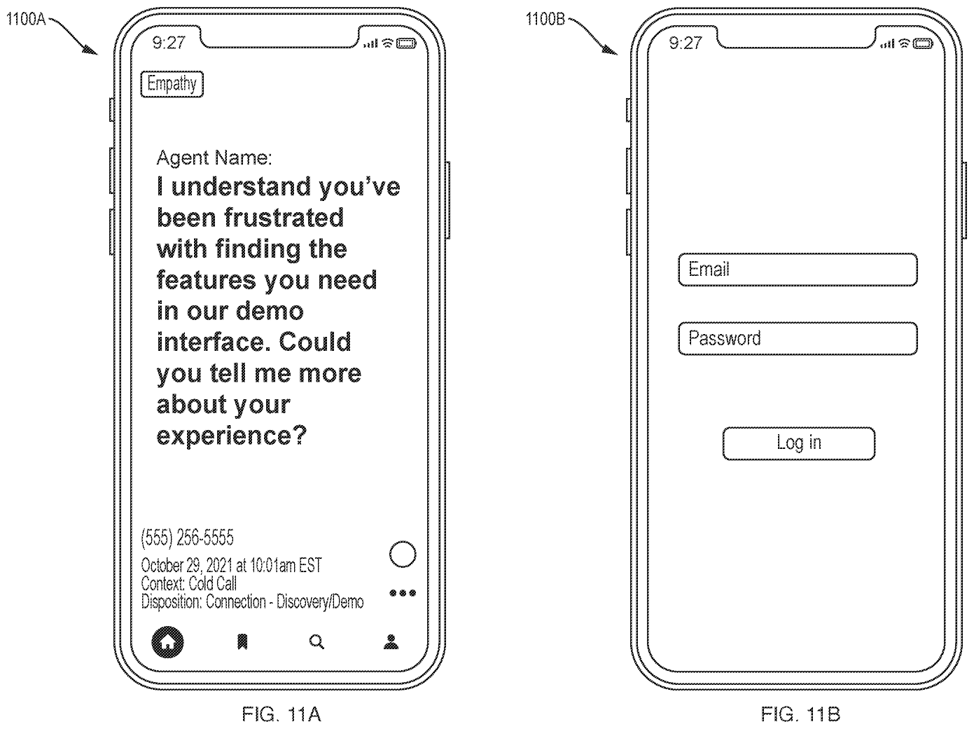

FIGS. 11A and 11B are visual representations 1100A and 1100B, respectively, of screens in a dark mode that may be selected by a user via a preferences screen, such as the preferences screen of FIG. 6B, disclosed above for non-limiting example.

FIG. 12 is a block diagram of an example of the internal structure of a computer 1200 in which various embodiments of the present disclosure may be implemented. The computer 1200 contains a system bus 1252, where a bus is a set of hardware lines used for data transfer among the components of a computer or digital processing system. The system bus 1252 is essentially a shared conduit that connects different elements of a computer system (e.g., processor, disk storage, memory, input/output ports, network ports, etc.) that enables the transfer of information between the elements. Coupled to the system bus 1252 is an I/O device interface 1254 for connecting various input and output devices (e.g., keyboard, mouse, displays, printers, speakers, etc.) to the computer 1200. A network interface 1256 allows the computer 1200 to connect to various other devices attached to a network (e.g., global computer network, wide area network, local area network, etc.). Memory 1258 provides volatile or non-volatile storage for computer software instructions 1260 and data 1262 that may be used to implement embodiments (e.g., methods of flow diagrams 400, 500) of the present disclosure, where the volatile and non-volatile memories are examples of non-transitory media. Disk storage 1264 provides non-volatile storage for computer software instructions 1260 and data 1262 that may be used to implement embodiments (e.g., methods of flow diagrams 400, 500) of the present disclosure. A central processor unit 1266 is also coupled to the system bus 1252 and provides for the execution of computer instructions.

Example embodiments disclosed herein may be configured using a computer program product; for example, controls may be programmed in software for implementing example embodiments. Further example embodiments may include a non-transitory computer-readable medium that contains instructions that may be executed by a processor, and, when loaded and executed, cause the processor to complete methods described herein. It should be understood that elements of the block and flow diagrams may be implemented in software or hardware, such as via one or more arrangements of circuitry of FIG. 12, disclosed above, or equivalents thereof, firmware, a combination thereof, or other similar implementation determined in the future.

In addition, the elements of the block and flow diagrams described herein may be combined or divided in any manner in software, hardware, or firmware. If implemented in software, the software may be written in any language that can support the example embodiments disclosed herein. The software may be stored in any form of computer readable medium, such as random-access memory (RAM), read-only memory (ROM), compact disk read-only memory (CD-ROM), and so forth. In operation, a general purpose or application-specific processor or processing core loads and executes software in a manner well understood in the art. It should be understood further that the block and flow diagrams may include more or fewer elements, be arranged or oriented differently, or be represented differently. It should be understood that implementation may dictate the block, flow, and/or network diagrams and the number of block and flow diagrams illustrating the execution of embodiments disclosed herein.

While example embodiments have been particularly shown and described, it will be understood by those skilled in the art that various changes in form and details may be made therein without departing from the scope of the embodiments encompassed by the appended claims.

What is claimed is:

1. A computer-implemented method comprising:
locating, automatically via at least one processor, a key moment of a call in a representation of the call; and
creating, automatically via the at least one processor, a snippet of the representation of the call based on the key moment located, the snippet including the key moment and context for the key moment, the context including a lead portion and a lag portion, the lead portion preceding the key moment in the representation of the call, the lag portion following the key moment in the representation of the call.

2. The computer-implemented method of claim 1, further comprising outputting, automatically via the at least one processor, a representation of the snippet, and wherein the outputting includes storing the representation of the snippet in at least one memory, outputting the representation of the snippet as audio, outputting the representation of the snippet as text representing the audio, or a combination thereof.

3. The computer implemented method of claim 1, wherein the representation of the call is an audio recording of the call or an audio transcript of the audio recording.

4. The computer-implemented method of claim 1, wherein the call is between an agent and a customer, wherein the agent is a sales agent, wherein the call is a sales call, wherein the key moment is an utterance spoken by the sales agent or the customer, and wherein the key moment is an utterance identified by an artificial intelligence (AI) model as having a positive or negative impact on a sales outcome.

5. The computer-implemented method of claim 1, wherein the key moment is an utterance identified by an AI model as having a positive or negative impact on an outcome effectuated by the call.

6. The computer-implemented method of claim 1, wherein the call is between an agent and a customer, wherein the lead portion includes at least one utterance spoken by the agent or customer prior to the key moment and wherein the lag portion includes at least one utterance spoken by the agent or customer after the key moment.

7. The computer-implemented method of claim 1, wherein the call is between an agent and a customer, wherein the lead portion and lag portion represent at least ten seconds of talk time between the agent and customer immediately before and after the key moment, respectively.

8. The computer-implemented method of claim 1, further comprising outputting, automatically via the at least one processor, a representation of the snippet, wherein the outputting includes transmitting the representation of the snippet to an electronic device, wherein the transmitting is based on at least one filter setting received from the electronic device, and wherein the at least one filter setting corresponds to the key moment.

9. The computer-implemented method of claim 1, wherein the locating is based on an indicator of the key moment, wherein the indicator is a timestamp or tag included in metadata of the representation of the call, and wherein the computer-implemented method further comprises identifying the indicator by parsing the metadata.

10. The computer-implemented method of claim 1, further comprising, by the at least one processor:
identifying the key moment via at least one AI model;
producing an indicator for the key moment identified; and
locating the key moment based on the indicator produced.

11. The computer-implemented method of claim 1, further comprising locating the key moment based on a received indicator of the key moment.

12. The computer-implemented method of claim 1, wherein the call is between an agent and a customer, and wherein the method further comprises, by the at least one processor:
storing, in at least one memory, a collection of snippets associated with the agent; and
adding the snippet created to the collection stored, wherein the snippet created is searchable and filterable in the collection stored in the at least one memory, by the at least one processor, based on the key moment.

13. The computer-implemented method of claim 1, further comprising, by the at least one processor:
adding the snippet created to a collection of snippets stored in at least one memory, each snippet of the snippets associated with a respective key moment;
retrieving the collection stored from the at least one memory responsive to receipt of an application specific interface (API) call, the API call issued by a mobile application (app) executing on a mobile device, the API call including a filter;
searching the collection retrieved based on the filter;
locating the snippet created in the collection retrieved and searched in an event the filter identifies the key moment; and
outputting a representation of the snippet created, automatically, to the mobile app of the mobile device in an event the snippet created is located.

14. The computer-implemented method of claim 1, wherein the call is between an agent and a customer, and wherein the method further comprises, by the at least one processor:
adding the snippet created to a plurality of snippets of a collection stored in at least one memory, the collection associated with the agent;
retrieving the collection stored from the at least one memory responsive to receipt of an API call, the API call issued by a mobile app of a mobile device; and
outputting, on a snippet-by-snippet basis, respective representations of snippets of the plurality of snippets of the collection retrieved to the mobile app of the mobile device.

15. A computer-implemented method comprising, by at least one processor:
issuing an application programming interface (API) call to retrieve a collection of snippets associated with calls between an agent and at least one customer, the collection associated with the agent; and
automatically playing snippets from the collection retrieved via the API call, the playing including producing an audible representation of the snippets, a visual representation of the snippets, or a combination thereof, on snippet-by-snippet basis, the snippets including respective key moments and associated context from representations of the calls between the agent and the at least one customer, the associated context including a lead portion and a lag portion, the lead portion preceding a respective key moment in a representation of a call of the representations of the calls, the lag portion following the respective key moment in the representation of the call.

16. A mobile device including at least one processor, the at least one processor configured to:
issue an application programming interface (API) call to retrieve a collection of snippets associated with calls between an agent and at least one customer, the collection associated with the agent; and
automatically play snippets from the collection retrieved via the API call, the playing including producing an audible representation of the snippets, a visual representation of the snippets, or a combination thereof, on snippet-by-snippet basis, the snippets including respective key moments and associated context from representations of the calls between the agent and the at least one customer, the associated context including a lead portion and a lag portion, the lead portion preceding a respective key moment in a representation of a call of the representations of the call, the lag portion following the respective key moment in the representation of the call.

17. A system comprising at least one processor, the at least one processor configured to:
locate, automatically, a key moment of a call in a representation of the call; and
create, automatically, a snippet of the representation of the call based on the key moment located, the snippet including the key moment and context for the key moment, the context including a lead portion and a lag portion, the lead portion preceding the key moment in the representation of the call, the lag portion following the key moment in the representation of the call.

18. The system of claim 17, wherein the at least one processor is further configured to output, automatically, a representation of the snippet, and wherein the outputting includes storing the representation of the snippet in at least one memory, outputting the representation of the snippet as audio, outputting the representation of the snippet as text representing the audio, or a combination thereof.

19. The system of claim 17, wherein the representation of the call is an audio recording of the call or an audio transcript of the audio recording.

20. The system of claim 17, wherein the call is between an agent and a customer, wherein the agent is a sales agent, wherein the call is a sales call, wherein the key moment is an utterance spoken by the sales agent or the customer, and wherein the key moment is an utterance identified by an artificial intelligence (AI) model as having a positive or negative impact on a sales outcome.

21. The system of claim 17, wherein the key moment is an utterance identified by an AI model as having a positive or negative impact on an outcome effectuated by the call.

22. The system of claim 17, wherein the call is between an agent and a customer, wherein the lead portion includes at least one utterance spoken by the agent or customer prior to the key moment and wherein the lag portion includes at least one utterance spoken by the agent or customer after the key moment.

23. The system of claim 17, wherein the call is between an agent and a customer, wherein the lead portion and lag portion represent at least ten seconds of talk time between the agent and customer immediately before and after the key moment, respectively.

24. The system of claim 17, wherein the at least one processor is further configured to output a representation of the snippet by transmitting the representation of the snippet to an electronic device, wherein the transmitting is based on at least one filter setting received from the electronic device, and wherein the at least one filter setting corresponds to the key moment.

25. The system of claim 17, wherein the at least on processor is further configured to locate the key moment based on an indicator of the key moment, wherein the indicator is a timestamp or tag included in metadata of the representation of the call, and wherein the at least one processor is further configured to identify the indicator by parsing the metadata.

26. The system of claim 17, wherein the at least one processor is further configured to:
identify the key moment via at least one AI model;
produce an indicator for the key moment identified; and
locate the key moment based on the indicator produced.

27. The system of claim 17, wherein the at least one processor is further configured to locate the key moment based on a received indicator of the key moment.

28. The system of claim 17, wherein the call is between an agent and a customer, wherein the at least one processor is further configured to:
store, in at least one memory, a collection of snippets associated with the agent;
add the snippet created to the collection stored, wherein the snippet created is searchable and filterable, in the collection stored in the at least one memory, by the at least one processor based on the key moment.

29. The system of claim 17, wherein the at least one processor is further configured to:
add the snippet created to a collection of snippets stored in at least one memory, each snippet of the snippets associated with a respective key moment;
retrieve the collection stored from the at least one memory responsive to receipt of an application specific interface (API) call, the API call issued by a mobile application (app) executing on a mobile device, the API call including a filter;
search the collection retrieved based on the filter;
locate the snippet created in the collection retrieved and searched in an event the filter identifies the key moment; and
output a representation of the snippet, automatically, to the mobile app of the mobile device in an event the snippet created is located.

30. The system of claim 17, wherein the call is between an agent and a customer, wherein the at least one processor is further configured to:
add the snippet created to a plurality of snippets of a collection stored in at least one memory, the collection associated with the agent;
retrieve the collection stored from the at least one memory responsive to receipt of an API call, the API call issued by a mobile app of a mobile device; and
output, on a snippet-by-snippet basis, respective representations of snippets of the plurality of snippets of the collection retrieved to the mobile app of the mobile device.

31. A non-transitory computer-readable medium having encoded thereon a sequence of instructions which, when loaded and executed by at least one processor, causes the at least one processor to:
locate, automatically, a key moment of a call in a representation of the call; and
create, automatically, a snippet of the representation of the call based on the key moment located, the snippet including the key moment and context for the key moment, the context including a lead portion and a lag portion, the lead portion preceding the key moment in the representation of the call, the lag portion following the key moment in the representation of the call.

32. A non-transitory computer-readable medium having encoded thereon a sequence of instructions which, when loaded and executed by at least one processor, causes the at least one processor to:
issue an application programming interface (API) call to retrieve a collection of snippets associated with calls between an agent and at least one customer, the collection associated with the agent; and
automatically play snippets from the collection retrieved via the API call, the playing including producing an audible representation of the snippets, a visual representation of the snippets, or a combination thereof, on snippet-by-snippet basis, the snippets including respective key moments and associated context from representations of the calls between the agent and the at least one customer, the associated context including a lead portion and a lag portion, the lead portion preceding a respective key moment in a representation of a call of the representations of calls, the lag portion following the respective key moment in the representation of the call.
